(19) United States
(12) Patent Application Publication
(10) Pub. No.: US 2012/0249275 A1
(43) Pub. Date: Oct. 4, 2012

(54) Insulation for Power Transformers

(75) Inventors: Thomas M. Golner, Pewaukee, WI (US); Shirish P. Mehta, Waukesha, WI (US); Padma P. Varanasi, Brookfield, WI (US)

(73) Assignee: Waukesha Electric Systems, Inc., Waukesha, WI (US)

(21) Appl. No.: 13/244,517

(22) Filed: Sep. 25, 2011

Related U.S. Application Data
(63) Continuation-in-part of application No. 12/540,437, filed on Aug. 13, 2009, now Pat. No. 8,085,120.

(51) Int. Cl. H01F 27/08; D02G 3/00; H01F 27/10

(52) U.S. Cl. 336/58; 336/55; 428/374

(57) ABSTRACT

A power transformer is provided that includes a first transformer component, a second transformer component, and a composite structure positioned between the first transformer component and the second transformer component. The composite structure includes a first composite fiber having at least one base fiber, a sheath of binder material, and nanoclay particles, and a second composite fiber, having at least one base fiber, bound to the first composite fiber by at least a portion of the sheath.

### CROSS-REFERENCE TO RELATED APPLICATIONS

This application is a Continuation-In-Part (CIP) of U.S. patent application Ser. No. 12/540,437, filed Aug. 13, 2009, which is incorporated herein by reference in its entirety.

### FIELD OF THE INVENTION

The present invention relates generally to insulation. More particularly, the present invention relates to insulation for power transformers.

### BACKGROUND OF THE INVENTION

Currently available high-voltage, fluid-filled power transformers utilize cellulose-based insulation materials that are impregnated with dielectric fluids. More specifically, such insulation systems include cellulose-based materials that are positioned between turns, between discs and sections, between layers, between windings and between components at high voltage and ground potential parts (e.g., cores, structural members and tanks).

In order to operate, currently available transformers typically include insulation materials that have a moisture content of less than 0.5% by weight. However, since cellulose naturally absorbs between 3 and 6 weight percent of moisture, a relatively costly process of heating under vacuum is typically performed before cellulose is suitable for use in a power transformer. Even pursuant to such a heating/vacuum process, as the cellulose ages (i.e., degrades over time), moisture eventually forms, as does acid, which accelerates the aging process.

Since the rate at which cellulose ages is dependent upon temperature, normal operating temperatures of currently available power transformers is 105° C. or less. For the same reason, the maximum operating temperature of such transformers is 120° C. or less. As more power is transferred, the higher losses due to higher current generate higher temperatures. As such, cellulose-based insulation systems limit the operational efficiency of power transformers.

### SUMMARY

Embodiments of the present invention advantageously provide insulation for power transformers.

In one embodiment, a power transformer includes a first transformer component, a second transformer component, and a composite structure positioned between the first transformer component and the second transformer component. The composite structure includes a first composite fiber having at least one base fiber, a sheath of binder material and nanoclay particles, and a second composite fiber, having at least one base fiber, which is bound to the first composite fiber by at least a portion of the sheath.

In another embodiment, a power transformer includes a first transformer component, a second transformer component, and a composite structure positioned between the first transformer component and the second transformer component. The composite structure includes a first composite fiber having at least one base fiber, a means for sheathing the base fiber, and a second composite fiber, having at least one base fiber, which is bound to the first composite fiber by at least a portion of the means for sheathing.

In a further embodiment, an insulating material for a power transformer includes a first composite fiber having at least one base fiber, a sheath of binder material and nanoclay particles, and a second composite fiber, having at least one base fiber, which is bound to the first composite fiber by at least a portion of the sheath.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a cross-section of a high-voltage, fluid-filled power transformer according to an embodiment of the present invention.

FIG. 2 includes a perspective view of a composite structure according to an embodiment of the present invention that may be used as part of an insulation system for the transformer illustrated in FIG. 1.

FIG. 3 includes a perspective view of a composite structure according to another embodiment of the present invention that also may be used as part of an insulation system for the transformer illustrated in FIG. 1.

FIG. 4 includes a perspective view of a composite structure according to yet another embodiment of the present invention that also may be used as part of an insulation system for the transformer illustrated in FIG. 1.

FIG. 5 is a flowchart illustrating steps of a method of fabricating a power transformer according to an embodiment of the present invention.

### DETAILED DESCRIPTION

In general, various embodiments of the present invention provide an improved electrical insulation, method of making the improved electrical insulation, and electrical system utilizing the improved electrical insulation. The improved electrical insulation generally includes a nanoclay or nanoclay particles. For the purpose of this disclosure, the term, “nanoclay” is defined as a mineral silicate particle in the size range of about 1 nanometer (nm) to about 10,000 nm. In general, examples of suitable nanoclays include silicates such as montmorillonite, bentonite, kaolinite, hectorite, halloysite, and the like. It is an advantage of one or more embodiments of the invention that the resulting electrical insulator has improved temperature performance such as, for example improved thermal stability; increased dimensional stability; improved flame retardant properties; increased modulus and tensile strengths; improved barrier properties against moisture, solvents, chemical vapors, and the like; lower density; and the like.

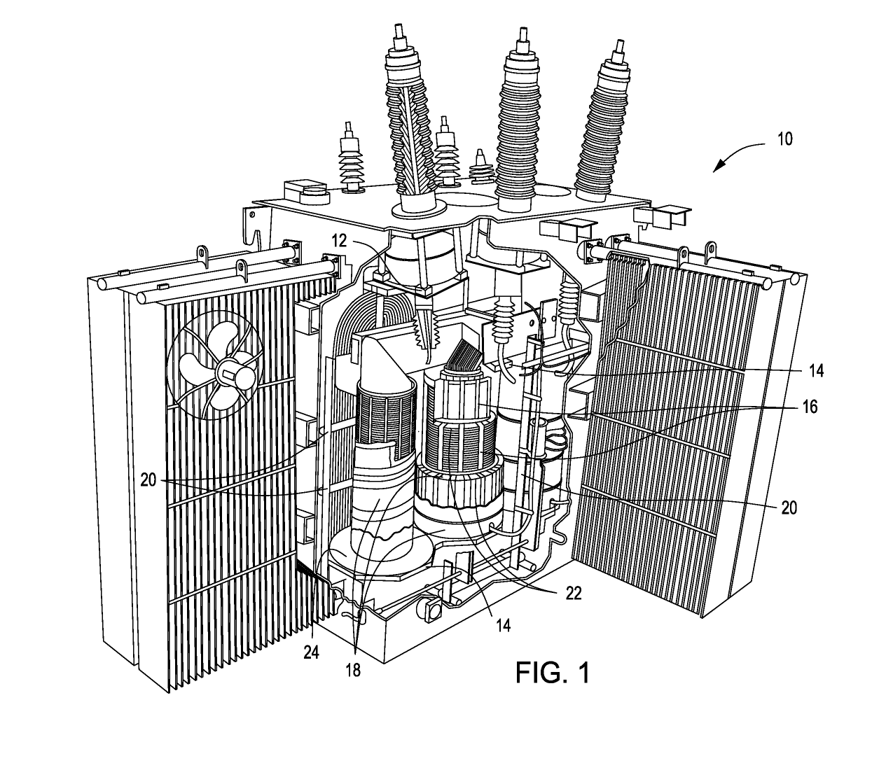

Embodiments of the present invention will now be described with reference to the drawing figures, in which like reference numerals refer to like parts throughout. FIG. 1 is a perspective view of a cross-section of a high-voltage, fluid-filled power transformer 10 according to an embodiment of the present invention. As illustrated in FIG. 1, the transformer 10 includes a variety of transformer components that all may have insulation positioned between and/or around them. More specifically, the transformer 10 includes current transformer (CT) supports 12, support blocks 14, locking strips 16, winding cylinders 18, lead supports 20, radical spacers 22 and end blocks 24. For purposes of clarity, the insulation is not illustrated in FIG. 1.

In operation, a cooling fluid (e.g., an electrical or dielectric insulating fluid such as, for example, a napthenic mineral oil, a paraffinic-based mineral oil including isoparaffins, synthetic esters and natural esters (e.g., FR3™) flows between the transformer components 12, 14, 16, 18, 20, 22, 24 and is in contact with the above-mentioned insulation, typically with at least some flow therethrough as well. For purposes of clarity, the cooling fluid is not illustrated in FIG. 1. The cooling fluid is selected not only to cool components within the transformer 10 during the operation thereof but also to physically withstand the conditions (e.g., temperature levels, voltage and current levels, etc.) found within the transformer 10 during the operation thereof. Further, the cooling fluid is selected to be chemically inert with respect to the transformer components and with respect to the insulation that is positioned between these components.

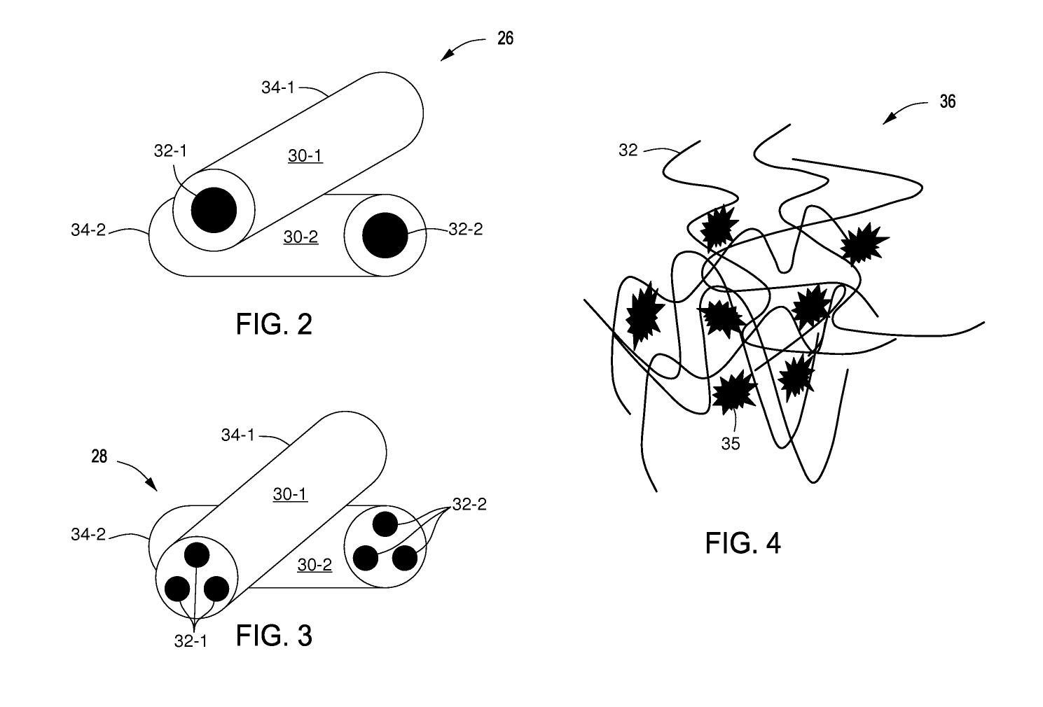

FIG. 2 includes a perspective view of a composite structure 26, according to an embodiment of the present invention that may be used as part of the above-mentioned insulation system for the transformer 10 illustrated in FIG. 1.

The composite structure 26 includes many composite fibers 30, each of which includes an least one base fiber 32. For convenience, two composite fibers 30-1 and 30-2 are depicted in FIG. 2, each having a single base fiber, i.e., base fiber 32-1 and base fiber 32-2. In one embodiment, all of the composite fibers 30 include a sheath 34 of binder material adhered to, extruded over, etc., their respective base fibers 32. As depicted in FIG. 2, sheaths 34-1 and 34-2 are bound to each other, which bind composite fibers 30-1 and 30-2 together. In another embodiment, at least some of the composite fibers 30 do not include a sheath 34 (not depicted for clarity), and are bound to those proximate composite fibers 30 that include a sheath 34.

In various embodiments of the invention, base fibers 30 and/or sheaths 34 include a suitable nanoclay. Particularly suitable nanoclays may be available at Sigma-Aldrich (St. Louis, Mo.). A specific example of a suitable nanoclay includes montmorillonite having about a 1 nm thick aluminosilicate layers surface-substituted with metal cations and stacked in about 10 μm-sized multilayer stacks. Depending on surface modification of the clay layers, montmorillonite may be dispersed in a polymer matrix to form polymer-clay nanocomposite. Within the nanocomposite individual nm-thick clay layers may be fully separated to form plate-like nanoparticles with very high (nm×μm) aspect ratio (e.g., 1:100, and the like).

Although smaller and larger dimensions are also within the scope of the present invention, the diameter of composite fiber 30 is typically on the order of microns and the length of each composite fiber 30 is typically on the order of millimeters or centimeters. As such, thousands or even millions of such composite fibers 30 are bound together to form the above-mentioned insulation system. The insulation system, once formed, is then positioned between the various components of the transformer 10 illustrated in FIG. 1. Since the sheath binder material does not form a continuous matrix, the above-mentioned cooling fluid is capable of impregnating and, at least to some extent, of flowing through the composite structure 26.

FIG. 3 includes a perspective view of a composite structure 28 according to another embodiment of the present invention that also may be used as part of an insulation system for the transformer 10 illustrated in FIG. 1.

In the composite structure 28, composite fibers 30 include several base fibers 32, such as, for example, two, three, four, etc., and sheath 34 adheres to, is extruded over, etc., all of the base fibers 32 of each composite fiber 30. For convenience, two composite fibers 30-1 and 30-2 are depicted in FIG. 3, each having three base fibers, i.e., base fibers 32-1 and base fibers 32-2. In one embodiment, all of the composite fibers 30 include a sheath 34, as illustrated in FIG. 3. The sheaths 34 are bound to each other, which bind composite fibers 30-1 and 30-2 together. In another embodiment, at least some of the composite fibers 30 do not include a sheath 34 (not depicted for clarity), and are bound to those proximate composite fibers 30 that include a sheath 34.

Advantageously, composite structure 26 is simple to fabricate, while composite structure 28 has greater mechanical strength.

FIG. 4 includes a perspective view of a composite structure 36 according to yet another embodiment of the present invention that also may be used as part of an insulation system for the transformer 10 illustrated in FIG. 1. In this embodiment, particles 35 of solid binding material are adhered to at least two base fibers 32. Composite structure 36 advantageously has a high porosity.

In general, base fibers 32 can be made from a suitable material. In some embodiments, base fibers 32 include a relatively high-melting-point thermoplastic material, while in other embodiments, base fibers 32 include a staple fiber material, such as, for example, natural materials such as, for example, raw cotton, wool, hemp, or flax. For example, materials contemplated by the present invention include one or more of polyethylene terephthalate (PET), polyphenylene sulphide (PPS), polyetherimide (PEI), polyethylene naphthalate (PEN) and polyethersulfone (PES). According to certain embodiments of the present invention, base fibers 32 are made from materials/composites/alloys that are mechanically and chemically stable at the maximum operating temperature of the transformer 10. Also, base fibers 32 can be made from materials/composites/alloys that are mechanically and chemically stable at the melting temperature of sheaths 34.

Base fibers 32 can be formed from the same material, or, alternatively, some of the base fibers 32 can be formed from one or more different materials. For example, referring to FIGS. 2 and 3, base fiber 32-1 can be made from a different material than base fiber 32-2.

Similarly, sheaths 34 can be made from a suitable material. In certain embodiments, sheaths 34 include at least one of an amorphous and a crystalline thermoplastic material that is mechanically and chemically stable when in contact with the above-mentioned cooling fluid. In one embodiment, sheaths 34 include at least one of a copolymer of polyethylene terephthalate (CoPET), amorphous PET, polybutylene terephthalate (PBT) and undrawn polyphenylene sulphide (PPS).

While no particular restrictions are generally placed upon the relative weight or volume percentages of composite fibers 30 to sheaths 34, in certain embodiments of the present invention, the weight ratio of composite fibers 30 to sheaths 34 is between approximately 8:1 and approximately 1:1. Also, although other densities are also contemplated by the present invention, composite structures 26, 28, 36 have densities of between approximately 0.5 g/cm³ and approximately 1.20 g/cm³. Further, according to certain embodiments of the present invention, the material(s) for the composite fibers 30 and the sheaths 34 are selected to have dielectric characteristics that are substantially similar to those of the cooling fluid used in the transformer 10.

As mentioned above, nanoclay particles may be added to base fibers 32 and/or sheaths 34, such as, for example, silicates such as montmorillonite, bentonite, kaolinite, hectorite, halloysite, and the like in the size range of about 1 nm to about 10,000 nm. More particularly, the nanoclay may include plate-like particles having a size of about 1 nm to about 100 nm in height and a length and width of about 10 to 100 times the height. In many embodiments, composite fibers 30 may include any suitable amount of the nanoclay. Examples of suitable amounts includes about 0.1% weight/weight (w/w) to about 60% w/w. In one example, the nanoclay may be about 0.5 to 7% w/w of the composite fibers 30.

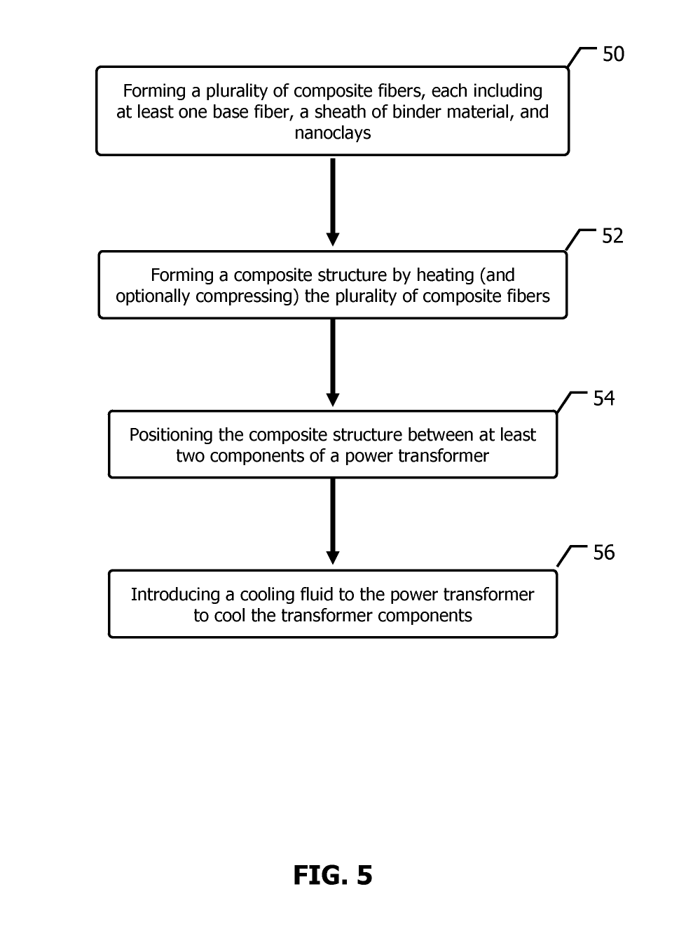

FIG. 5 is a flowchart illustrating steps of a method for insulating a power transformer 10, according to an embodiment of the present invention.

A plurality of composite fibers 30 are formed (50). Each composite fiber includes at least one base fiber 32, a sheath 34 of binder material and nanoclays. In one embodiment, nanoclays are included only in the base fibers 32, in another embodiment, nanoclays are included only in the sheaths 34, while in a further embodiment, nanoclays are included in both the base fibers 32 and the sheaths 34. According to certain embodiments of the present invention, sheaths 34 are can be formed by co-extruding binder material onto base fibers 32; other processes are also contemplated.

A composite structure 26, 28 is formed (52) by heating the plurality of composite fibers 30, which melts the sheaths 34 and binds the composite fibers 30 together. Compression may also be used to advantage, either before, during or after heating. According to certain embodiments of the present invention, heating and optionally compressing produce a composite structure having a density of between approximately 0.5 g/cm³ and approximately 1.20 g/cm³. Other densities are also within the scope of the present invention. In addition to increasing the overall density of the composite structure, compression may stretch some of the composite fibers 30 contained therein, which results in an increased crystallinity in the composite structure, which can be beneficial in certain instances.

The composite structure 26, 28 is positioned (54) between at least two components of a power transformer. For example, the composite structure may be placed between any or all of the current transformer (CT) supports 12, support blocks 14, locking strips 16, winding cylinders 18, lead supports 20, radical spacers 22 and/or end blocks 24 illustrated in FIG. 1. As such, according to certain embodiments of the present invention, the composite structure may be formed into one or more shapes that may be easily introduced into various spaces within power transformer 10.

A cooling fluid is introduced (56) into the power transformer. The cooling fluid cools the power transformer components and fluidly couples the composite structure 26, 28 and the transformer components. The cooling fluid may be, for example, an electrical or dielectric insulating fluid. Because of the high porosity of the composite material 26, 28, the cooling liquid will substantially permeate the composite material 26, 28, and provide better dielectric properties than other known structures. Additionally, the base fiber and binder material can be selected for dielectric characteristics that are substantially similar to those of the cooling fluid. Such a selection of dielectrically compatible materials allows for more efficient operation of power transformers according to the present invention.

As will be appreciated by one of skill in the art upon practicing one or more embodiments of the present invention, several advantages are provided by the apparatuses and methods discussed above. For example, the insulation systems discussed above may allow for the power transformers in which they are included to operate at higher temperatures. In fact, according to certain embodiments of the present invention, operating temperature range of between 155° C. and 180° C. are attainable, though these temperature ranges are not limiting of the overall invention. Since higher operating temperature reduce the size requirements of power transformers, transformers according to the present invention designed for a particular application may be smaller than currently available transformers, thereby requiring fewer materials and reducing the overall cost of forming/manufacturing the transformer.

Because of the enhanced insulating and cooling of certain power transformers according to the present invention, more megavolt ampere (MVA) (i.e., electrical power) may be provided from transformers having a smaller physical footprint than currently available transformers. Also, because of the novel composition of the components in the above-mentioned insulation systems, certain transformers according to the present invention reduce the probability of endangering the reliability of the transformer due to thermal overload. In addition, the novel structure of the insulation systems discussed above make them more capable of retaining their compressible characteristics over time then currently available systems (i.e., there is less creep and no need to re-tighten).

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A power transformer, comprising:
a first transformer component;
a second transformer component; and
a composite structure, positioned between the first transformer component and the second transformer component, including:
a first composite fiber having at least one base fiber, a sheath of binder material, and nanoclay particles, and
a second composite fiber, having at least one base fiber, bound to the first composite fiber by at least a portion of the sheath.

2. The power transformer of claim 1, further comprising a cooling fluid, fluidly coupled to the first transformer component, the second transformer component and the composite structure, to cool the first transformer component and the second transformer component during operation.

3. The power transformer of claim 1, wherein the nanoclay particles are included only in the sheath.

4. The power transformer of claim 1, wherein the nanoclay particles are included only in the base fiber.

5. The power transformer of claim 1, wherein the second base fiber includes a sheath of binder material and nanoclay particles.

6. The power transformer of claim 5, wherein the nanoclay particles are included only in the base fiber or the sheath of the first and second composite fibers.

7. The power transformer of claim 1, wherein the composite structure has a weight/weight (w/w) ratio of nanoclay particles of between 0.1% and 60%.

8. The power transformer of claim 7, wherein the composite structure has a w/w ratio of nanoclay particles of between 0.5% and 7%.

9. The power transformer of claim 1, wherein the nanoclay particles include spherical particles have an average diameter of between 1 nm and 10,000 nm.

10. The power transformer of claim 1, wherein the nanoclay particles include plate-like particles having a height between 1 nm to 100 nm, a length of between 10 to 100 times the height, and a width of between 10 to 100 times the height.

11. The power transformer of claim 1, wherein the nanoclay particles include silicates selected from the group consisting of montmorillonite, bentonite, kaolinite, hectorite, and halloysite.

12. The power transformer of claim 11, wherein the nanoclay particles include montmorillonite.

13. The power transformer of claim 1, wherein the base fibers include a high melting point thermoplastic material.

14. The power transformer of claim 1, wherein the base fibers includes at least one of polyethylene terephthalate (PET), polyphenylene sulphide (PPS), polyetherimide (PEI), polyethylene naphthalate (PEN) and polyethersulfone (PES).

15. The power transformer of claim 1, wherein the sheath includes at least one of a copolymer of polyethylene terephthalate (CoPET), amorphous PET, polybutylene terephthalate (PBT) and undrawn polyphenylene sulphide (PPS).

16. The power transformer of claim 1, wherein the sheath extends along a portion of the base fiber.

17. The power transformer of claim 1, wherein the composite structure has a density of between 0.5 g/cm³ and 1.20 g/cm³.

18. A power transformer, comprising:
a first transformer component;
a second transformer component; and
a composite structure, positioned between the first transformer component and the second transformer component, including:
a first composite fiber having at least one base fiber, a means for sheathing the base fiber, and
a second composite fiber, having at least one base fiber, bound to the first composite fiber by at least a portion of the means for sheathing.

19. The power transformer of claim 18, further comprising a cooling fluid, fluidly coupled to the first transformer component, the second transformer component and the composite structure, to cool the first transformer component and the second transformer component during operation.

20. An insulating material for a power transformer, comprising:
a first composite fiber having at least one base fiber, a sheath of binder material, and nanoclay particles, and
a second composite fiber, having at least one base fiber, bound to the first composite fiber by at least a portion of the sheath.
